(19) United States
(12) Patent Application Publication
(10) Pub. No.: US 2023/0306349 A1
(43) Pub. Date: Sep. 28, 2023

(54) BENCHMARKING PROCESSES OF AN ORGANIZATION TO STANDARDIZED PROCESSES

(71) Applicant: UiPath, Inc., New York, NY (US)

(72) Inventors: Palak Kadakia, Redmond, WA (US); Matthew Vanderzee, Sammamish, WA (US)

(73) Assignee: UiPath, Inc., New York, NY (US)

(21) Appl. No.: 17/654,793

(22) Filed: Mar. 14, 2022

(51) Int. Cl. G06Q 10/06

(52) U.S. Cl. CPC G06Q 10/06393

(57) ABSTRACT

Systems and methods for automatically benchmarking a process of an organization are provided. A process of an organization is extracted from a database of process data. A semantic understanding of the process of the organization is determined. The process of the organization is benchmarked to a standardized process based on the semantic understanding. Results of the benchmarking are output.

### TECHNICAL FIELD

The present invention relates generally to benchmarking processes, and more particularly to benchmarking processes of an organization to standardized processes.

### BACKGROUND

Benchmarking is the practice of comparing processes for an organization to those of other organizations. Conventionally, benchmarking of processes of an organization is performed manually. However, such conventional benchmarking of processes is cumbersome and slow, as it can only focus on a narrow part of a process and it would be impossible to manually evaluate the overall business activities. Further, because such conventional benchmarking is manual, it is impossible to objectively and deterministically identify improvement opportunities.

### BRIEF SUMMARY OF THE INVENTION

In accordance with one or more embodiments, systems and methods for automatically benchmarking a process of an organization are provided. A process of an organization is extracted from a database of process data. A semantic understanding of the process of the organization is determined. The process of the organization is benchmarked to a standardized process based on the semantic understanding. Results of the benchmarking are output. The process may be an RPA (robotic process automation) process.

In one embodiment, the semantic understanding of the process is determined based on at least one of task mining data, process mining data, or robot execution data. The standardized process may be generated based on process data of a plurality of organizations. The process of the organization may be benchmarked to the standardized process based on at least one of speed, conformance, or a human intervention index. Opportunities for improving the process of the organization may be identified based on results of the benchmarking.

These and other advantages of the invention will be apparent to those of ordinary skill in the art by reference to the following detailed description and the accompanying drawings.

### BRIEF DESCRIPTION OF THE DRAWINGS

FIG. 1 shows a method for benchmarking a process of an organization, in accordance with one or more embodiments; and

FIG. 2 is a block diagram of a computing system according to an embodiment of the invention.

### DETAILED DESCRIPTION

Embodiments described herein provide for benchmarking a process of an organization to a standardized process. Such benchmarking is performed based on a semantic understanding of the process of the organization, which enables both granular evaluation of all parts of an overall process as well as a rigorous rollup of all parts of a business activity. Advantageously, such granular benchmarking allows broad identification of improvement opportunities.

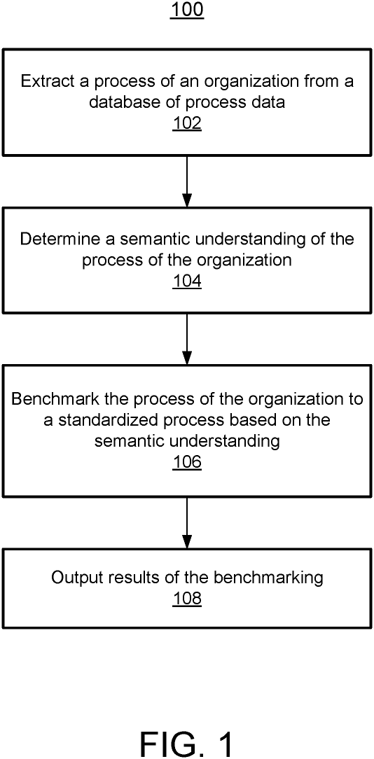

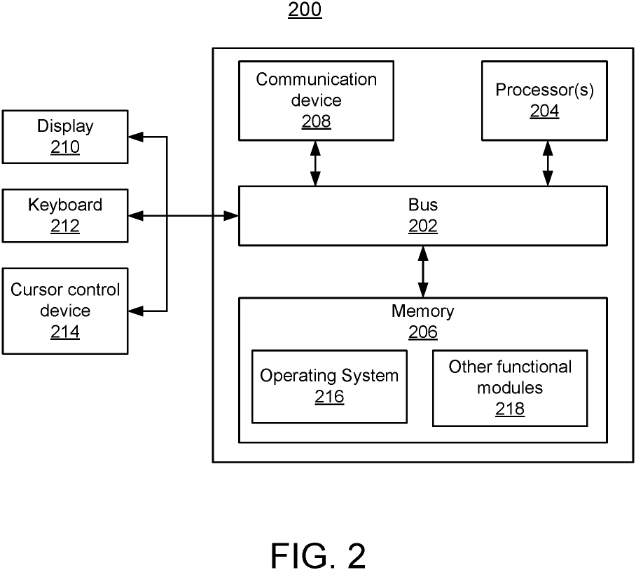

FIG. 1 shows a method 100 for benchmarking a process of an organization, in accordance with one or more embodiments. The steps of method 100 may be performed by any suitable computing device, such as, e.g., computing system 200 of FIG. 2.

At step 102, a process of an organization is extracted from a database of process data. In one example, the process is a process for processing an invoice. However, the process may be any suitable process of the organization. In one embodiment, the process is an RPA (robotic process automation) process automatically performed by one or more RPA software robots. The database of process data comprises process data of the organization. The process data is acquired using machine learning and/or rule-based techniques. The process may be extracted from the database using any suitable technique. In one embodiment, the process is extracted from the database by process discovery or any other suitable process mining technique.

At step 104, a semantic understanding of the process of the organization is determined. The semantic understanding describes an interpretation of the underlying process data for the process. The semantic understanding may comprise a mapping of data entities of the process data to a higher-level, human-understandable data model. The semantic understanding may also comprise a mapping of data entities of the process data to common terms and concepts for a given process space or industry. For example, in payment processes, common entities include invoices, vendors, and payments. The semantic understanding of the process may comprise a mapping of the process data to a data model that includes these common entities. A semantic understanding of the process is determined by transforming the raw process data into a graph or data structure that matches how experts in the field would describe the entities/data/process.

In one embodiment, the semantic understanding is determined by automatically mapping the process data to the common data entities. In one example, the mapping is performed by relating labels and metadata of the process data to common labels and metadata in industry standard entities. In another example, the mapping is performed by pattern matching. In a further example, the mapping is performed by comparing the data entities and their entity connectivity of the process data to common process- or industry-specific entities and their entity connectivity. For example, for a purchasing process, the process data may comprise a data entity that is involved with multiple invoices, whose metadata includes a tax ID number. These contextual clues (and possibly others) are used to map this data entity to a vendor.

In another embodiment, the semantic understanding is determined by performing task mining on the process data to generate task mining data. As used herein, task mining refers to the automatic identification of tasks (e.g., manual repetitive tasks) by observing (e.g., real time or near real time monitoring or offline analysis) user interaction (e.g., explicit user input or inferred user activity) on applications. The task mining data defines interactions between entities and users in the process data. Because the business data sources include execution information from the users who are participating in the process, it comprises a variety of contextual information that can help build a semantic understanding. For example, if a user is working on a purchasing process and is responsible for approving an invoice, the user will at various points in the process be presented with invoice data. That visualization of the data will include UI (user interface) labels that make sense to the user. These labels can provide contextual clues as to what the data being presented actually represents. Extracting this UI context and connecting it to the underlying process data allows the entities of the process data to be automatically defined in a semantically correct way.

The semantic understanding may be determined at each level of the process using any other suitable discovery technique. For example, the semantic understanding may be determined from process mining data or robot execution data. The robot execution data defines interactions between the entities and robots. In one embodiment, the robot execution data is data relating to the execution of an RPA process executed by one or more RPA robots.

At step 106, the process of the organization is benchmarked to a standardized process based on the semantic understanding. The standardized process is generated based on process data from a plurality of organizations. In one embodiment, the standardized process may be derived algorithmically from a plurality of similar processes. For example, where the process of the organization is a purchasing process, the standardized process may be derived as a weighted average of similar processes, where those processes that are more efficient or successful are weighted more heavily. In another embodiment, the standardized process may be manually defined by user such as, e.g., an expert in the field. In a further embodiment, the standardized process may be designed using automations, such as, e.g., RPA robots, etc. In other words, if there exists a predefined process implemented via robots, which represents an optimized instantiation of the process of the organization, this can be the standardized process that non-automated processes are compared to.

The benchmarking may be performed by comparing the process of the organization to the standardized process. In one embodiment, the benchmarking is performed by comparing parameters of the process of the organization and the standardized process so that the organization can learn how well they are doing versus the standardized process. Such parameters may comprise, e.g., quickest, efficiency, throughput, latency, error rate, human involvement, most conforming, human intervention index, or any other suitable parameter or metric (e.g., key business metrics). In another embodiment, the benchmarking is performed by comparing the process graph of the organization with the standardized process graph mathematically or algorithmically to qualitatively determine how the organization’s process diverges from the standardized process. For example, if there are semantic entities missing from the process of the organization, that might suggest that the organization is missing a typical part of the process. For example, the organization might be missing a typical invoice review step of a purchasing process, and this might inform the organization that they are missing a purchasing safety check.

The benchmarking may yield quantitative results, such as, e.g., how much time or money could be saved, how their process error rate could be improved, etc. The benchmarking may also yield qualitative results, such as, e.g., how the process materially differs from the standardized process. These qualitative results can inform next steps for process improvement: automation strategies, organizational adjustments, etc.

The process of the organization is compared with the standardized process to benchmark the process of the organization to the standardized process and determine a deviation or variance of the process of the organization from the standardized process. When the process of the organization and standardized process are compared, the differences between the process of the organization and standardized process are analyzed. Those differences might be interpreted as single-node differences, for example a single step of the process has an alternative option that would improve the process operation. Alternately, there may be whole sections of the knowledge graph of the organization that might be replaced by a new subgraph. These two subgraphs can be compared to understand how to get from the subgraph of the process of the organization to the subgraph of the standardized process. In some cases, it is a simple rearrangement of the nodes, as in do Step B before Step A. In other cases, there may be differences only in the metadata for a step, as in there may be a new sequence of activities that will yield better outcomes than the current. In still other cases, the differences might be the absence/presence of automation - whole subgraphs may be replaced by a single automated step.

At step 108, results of the benchmarking are output. For example, the results of the benchmarking may be output by displaying the results on a display device of a computer system, storing the results on a memory or storage of a computer system, or by transmitting the results to a remote computer system.

In one embodiment, opportunities for improving the process of the organization may be identified based on the results of the benchmarking.

In one exemplary use case, a plurality of organizations utilizes an order-to-cash process. A standardized process is generated from process data of the order-to-cash process for the plurality of organizations. The order-to-cash process for each of the plurality of organizations may be benchmarked to the standardized process to determine variances or deviations of each of the processes to the standardized process. The variances or deviations may be utilized to determine opportunities for improving the processes.

FIG. 2 is a block diagram illustrating a computing system 200 configured to execute the methods, workflows, and processes described herein, including method 100 of FIG. 1, according to an embodiment of the present invention. In some embodiments, computing system 200 may be one or more of the computing systems depicted and/or described herein. Computing system 200 includes a bus 202 or other communication mechanism for communicating information, and processor(s) 204 coupled to bus 202 for processing information. Processor(s) 204 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 204 may also have multiple processing cores, and at least some of the cores may be configured to perform specific functions. Multi-parallel processing may be used in some embodiments.

Computing system 200 further includes a memory 206 for storing information and instructions to be executed by processor(s) 204. Memory 206 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 204 and may include volatile media, non-volatile media, or both. The media may also be removable, non-removable, or both.

Additionally, computing system 200 includes a communication device 208, such as a transceiver, to provide access to a communications network via a wireless and/or wired connection according to any currently existing or future-implemented communications standard and/or protocol.

Processor(s) 204 are further coupled via bus 202 to a display 210 that is suitable for displaying information to a user. Display 210 may also be configured as a touch display and/or any suitable haptic I/O (input/output) device.

A keyboard 212 and a cursor control device 214, such as a computer mouse, a touchpad, etc., are further coupled to bus 202 to enable a user to interface with computing system. However, in certain embodiments, a physical keyboard and mouse may not be present, and the user may interact with the device solely through display 210 and/or a touchpad (not shown). Any type and combination of input devices may be used as a matter of design choice. In certain embodiments, no physical input device and/or display is present. For instance, the user may interact with computing system 200 remotely via another computing system in communication therewith, or computing system 200 may operate autonomously.

Memory 206 stores software modules that provide functionality when executed by processor(s) 204. The modules include an operating system 216 for computing system 200 and one or more additional functional modules 218 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method comprising:
extracting a process of an organization from a database of process data;
determining a semantic understanding of the process of the organization;
benchmarking the process of the organization to a standardized process based on the semantic understanding; and
outputting results of the benchmarking.

2. The computer-implemented method of claim 1, wherein determining a semantic understanding of the process of the organization comprises:
determining the semantic understanding of the process based on at least one of task mining data, process mining data, or robot execution data.

3. The computer-implemented method of claim 1, wherein the standardized process is generated based on process data of a plurality of organizations.

4. The computer-implemented method of claim 1, wherein benchmarking the process of the organization to a standardized process based on the semantic understanding comprises:
benchmarking the process of the organization to the standardized process based on at least one of speed, conformance, or a human intervention index.

5. The computer-implemented method of claim 1, further comprising:
identifying opportunities for improving the process of the organization based on results of the benchmarking.

6. The computer-implemented method of claim 1, wherein the process is an RPA (robotic process automation) process.

7. An apparatus comprising:
a memory storing computer instructions; and
at least one processor configured to execute the computer instructions, the computer instructions configured to cause the at least one processor to perform operations of:
extracting a process of an organization from a database of process data;
determining a semantic understanding of the process of the organization;
benchmarking the process of the organization to a standardized process based on the semantic understanding; and
outputting results of the benchmarking.

8. The apparatus of claim 7, wherein determining a semantic understanding of the process of the organization comprises:
determining the semantic understanding of the process based on at least one of task mining data, process mining data, or robot execution data.

9. The apparatus of claim 7, wherein the standardized process is generated based on process data of a plurality of organizations.

10. The apparatus of claim 7, wherein benchmarking the process of the organization to a standardized process based on the semantic understanding comprises:
benchmarking the process of the organization to the standardized process based on at least one of speed, conformance, or a human intervention index.

11. The apparatus of claim 7, the operations further comprising:
identifying opportunities for improving the process of the organization based on results of the benchmarking.

12. The apparatus of claim 7, wherein the process is an RPA (robotic process automation) process.

13. A non-transitory computer-readable medium storing computer program instructions, the computer program instructions, when executed on at least one processor, cause the at least one processor to perform operations comprising:
extracting a process of an organization from a database of process data;
determining a semantic understanding of the process of the organization;
benchmarking the process of the organization to a standardized process based on the semantic understanding; and
outputting results of the benchmarking.

14. The non-transitory computer-readable medium of claim 13, wherein determining a semantic understanding of the process of the organization comprises:
determining the semantic understanding of the process based on at least one of task mining data, process mining data, or robot execution data.

15. The non-transitory computer-readable medium of claim 13, wherein the standardized process is generated based on process data of a plurality of organizations.

16. The non-transitory computer-readable medium of claim 13, wherein benchmarking the process of the organization to a standardized process based on the semantic understanding comprises:
benchmarking the process of the organization to the standardized process based on at least one of speed, conformance, or a human intervention index.

17. The non-transitory computer-readable medium of claim 13, the operations further comprising:
identifying opportunities for improving the process of the organization based on results of the benchmarking.

18. The non-transitory computer-readable medium of claim 13, wherein the process is an RPA (robotic process automation) process.
